(19) United States
(12) Patent Application Publication
(10) Pub. No.: US 2018/0107580 A1
(43) Pub. Date: Apr. 19, 2018

(54) METADATA ENABLED COMPARISON OF USER INTERFACES

(71) Applicant: MICROSOFT TECHNOLOGY LICENSING, LLC, Redmond, WA (US)

(72) Inventors: YU ZHANG, Sammamish, WA (US); MICHAEL JOSEPH EATHERLY, Puyallup, WA (US); SWATI GUPTA, Kirkland, WA (US)

(21) Appl. No.: 15/293,702

(22) Filed: Oct. 14, 2016

(51) Int. Cl. G06F 11/36; G06K 9/64; G06K 9/32

(52) U.S. Cl. CPC G06F 11/3604; G06K 9/64; G06K 2209/03; G06K 2209/27; G06K 9/3258

(57) ABSTRACT

Systems and methods are provided for identifying changes in a user interface between versions of an application, web page, or other product/service that includes the user interface. This can include matching changes in the visual appearance of the user interface with changes in the text strings presented in the user interface. Identifying user interfaces where the changes in the user interface image are matched with changes to the text associated with user interface objects in the user interface can allow improved identification of user interfaces that have changed.

### BACKGROUND

One of the challenges in providing updates for existing computing applications (including mobile “apps”), web pages, or other products and/or services is verifying that such updates maintain proper functionality. One aspect of this challenge is maintaining operation of the various user interfaces that may be present within an application, web page, or other product and/or service. In particular, each different type of document or page view that can be presented to a user by an application or web page can be viewed as a separate user interface. Thus, maintaining proper operation of an application or web page after an update can involve verifying the operation of a plurality of user interfaces.

Traditionally, verifying an application after an update has involved maintaining close and timely communication with quality assurance testers and the developers for application updates. Unfortunately, any lapses in communication can result in a lack of awareness regarding which elements (if any) in a user interface require testing. Without accurate knowledge regarding user interface changes, testing efforts may end up focusing on validation of user interfaces that have not changed, leading to unnecessary costs in term of time and resources. Additionally or alternately, new and/or updated user interfaces might be missed and remain untested prior to release to end users.

### SUMMARY

Embodiments of the present invention are directed to systems and methods for characterizing the differences between versions of a user interface in an application. The application can correspond to a traditional application, a mobile “app”, a product or service offered via a network, or any other convenient type of product or service.

The differences between versions of a user interface as an application is changed can be identified by determining the difference between a baseline version of the user interface and a revised version of the user interface. This can include comparing images of the baseline version and the revised version, such as by comparing the images to determine differences between the pixels in the images. Determining the difference between a baseline version and a revised version can also include comparing text strings associated with user interface objects in the user interface. The comparison of the text strings can optionally be performed by comparing hash values associated with the text strings.

To further facilitate comparison, portions of the images and/or text strings can be excluded from consideration, such as by using a mask to identify portions of the image that correspond to excluded areas. Additionally or alternately, to further facilitate comparison, changes in the image can be matched to changes in the text string. When matched changes are identified, an increased ranking for the determined changes can be provided.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 shows an example of a process flow for performing a comparison between versions of a user interface;

FIG. 2 shows an example of a ranking scheme for ranking the differences between versions of a user interface;

FIG. 3 is an illustration of an exemplary embodiment of a tool for managing comparison of versions of a user interface;

FIG. 4 schematically shows an example of a system for performing a comparison between versions of a user interface;

FIG. 5 shows an example of a baseline version of a user interface;

FIG. 6 shows an example of a revised version of a user interface;

FIG. 7 shows another example of a revised version of a user interface;

FIG. 8 shows another example of a revised version of a user interface;

FIG. 9 shows an example of a process flow for determining changes between versions of a user interface; and

FIG. 10 is a block diagram of an exemplary computing environment suitable for use in implementing embodiments of the present invention.

### DETAILED DESCRIPTION

In various aspects, systems and methods are provided for automatically identifying changes in a user interface between versions of an application, web page, or other product/service that includes the user interface. This can include matching changes in the visual appearance of the user interface with changes in the text presented in the user interface and/or with changes in the underlying metadata for the user interface. Identifying user interfaces where the changes in the user interface image are matched (at least partially) with changes to the text associated with user interface objects in the user interface can allow improved identification of user interfaces that have changed sufficiently to warrant new testing to verify operation of the user interface. By contrast, by separately identifying changes in user interface images and changes in text associated with user interface objects, user interface changes that have a reduced or minimized need for further testing can be identified.

User interface testing when upgrading an application can present a variety of challenges. In this discussion, the definition of an application can include, but is not limited to, mobile applications, products and/or services provided as one or more web pages or web interfaces (such as a group of related web pages within a network domain), or another type of product/service that allows for user interaction via a set of structured documents or pages presented using a visual display. In this discussion, unless otherwise specified, a user interface generally refers to any document, page, display window, other display screen within an application (including a web page or other product/service) that may be presented to a user for interaction. Thus, a typical application can potentially include a large number of user interfaces. When an upgrade is performed, the number of user interfaces that are upgraded may be difficult to determine based on just a visual inspection. Due to the large number of potential user interfaces in an updated application, it can be undesirable to simply test all available user interfaces every time an upgrade is made to an application. However, manual identification of changed user interfaces (such as by visual comparison) can also be difficult.

One potential option for expediting user interface testing can be to perform image based testing. Comparing images or snapshots of versions of a user interface can allow for detection of small changes, as a pixel-level comparison can identify even small changes. However, such identification of small changes can actually hinder effective testing, as a version of a user interface can be identified as “changed” even though the only change corresponds to a change in color for a single pixel. Such small changes for image-only comparisons can result in having to test user interface versions that are essentially unchanged. This can consume substantial additional computing resources. Thus, the ability to determine not only differences in a user interface, but to also be able to characterize the changes as being significant enough to warrant testing or not, can allow for substantial savings in computational resources for an automated quality assurance process. In various aspects, this characterization of the significance of changes can be achieved in part by determining whether changes in the images for versions of a user interface are correlated with changes in the underlying metadata for the versions of the user interface.

The ability to efficiently identify user interfaces that require further testing can provide substantial savings of computational resources in a development environment. A typical application, such as a product or service provided via a series of web page interfaces, can often include a large plurality of user interfaces. This is because each separate web page interface/page display within an application can correspond to a separate user interface. When a revision is made to an application, each user interface can potentially requiring testing. If testing is performed in an incremental manner during product development, this can lead to a substantial computing load simply to perform a desired sequence of quality assurance tests on each different user interface. The systems and methods described herein can provide methods for distinguishing between user interfaces that have changed substantially between revisions of an application and user interfaces that have changed in a less substantial manner. This can allow testing to be performed on a smaller group of user interfaces, thus saving computational resources. Additionally or alternately, distinguishing between the types of changes in user interfaces can facilitate further review by a user, and therefore can facilitate human use of a computing system during product development.

Determining the amount of change in a user interface between versions of an application can be performed using a baseline version of a user interface and a “revised” version corresponding to the user interface from the revised version of the application (such as a web page). First, a baseline version a user interface can be identified and stored. The stored baseline version can include both a snapshot or image of the user interface as well as metadata associated with the user interface objects of the user interface. The metadata can include text that is displayed as part of or in association with user interface objects in the user interface. The metadata can also optionally include information regarding properties of the user interface objects in the user interface. The baseline user interface can correspond to any convenient prior version of a user interface, such as the initial version or the version after finishing a previous round of user interface testing.

When a new version of an application (such as a web page or other product/service) is detected, identified, or otherwise becomes available (such as in a development environment), the stored baseline image can be compared with a snapshot or image of the new version of the interface. In some aspects, the comparison of the baseline version image and the revised version image can be a comparison that detects any changes in the images, including changes in the positions or coordinates of user interface objects and/or text associated with a user interface object. In other aspects, the changes identified when comparing user interface versions can correspond to changes other than changes in the position/coordinates of text associated with a user interface object.

After determining whether changes are present between the user interface images, the text present in the baseline version and the revised version can also be compared. The text can typically correspond to text associated with objects in the user interface, but if text that is part of a user interface can somehow be present without being associated with a user interface object, such text can also be compared. Optionally, the comparison of text between the baseline version and the revised version can be performed by comparing a hash value for the text. This can allow one or more characteristic hash values to be computed ahead of time for a user interface. The hash values can be used for performing the comparison in any convenient manner. In some aspects, a single hash value can be computed for all text in a user interface. In other aspects, a separate hash value can be computed for each distinct text portion in a user interface, with distinct text portions being determined based on the user interface object a text portion is associated with. In still other aspects, only a portion of the text in a user interface can have a corresponding hash value. In such aspects, text without a corresponding hash value can optionally be omitted from a comparison of text between user interfaces. In yet other aspects, a combination of all of the above types of hash values can be used, such as having an overall hash value for all text and separate hash values for some or all of the distinct text portions in a user interface.

After comparing text from the user interface to identify changes, the identified text changes can be analyzed relative to the changes in the images to determine if any matches can be found between text changes and image changes. The text changes and image changes can be “matched” in the sense that the same portion of the user interface has an image change and a text change. For example, the presence of changes between a baseline version of a user interface image and a revised version of the user interface image can be based on identifying pixels that have changed, based on identifying user interface objects that have changed and/or moved, or a combination thereof. If text changes occur that are associated with a changed/moved user interface object, and/or if text changes occur that are within or near the identified changed pixels, the text changes can be considered to match an image change.

Optionally, the user interface objects from the new or revised version can also be compared with the stored version of the user interface objects (i.e., the baseline version) based on available metadata for the user interface. The objects can be compared based on the properties of the object, such as the properties as specified in XML code for the object, whether the source directory for the object has been changed, and/or whether the position for the object has changed. After determining changes to the image, any changes in the objects that match a change in the image can also be identified.

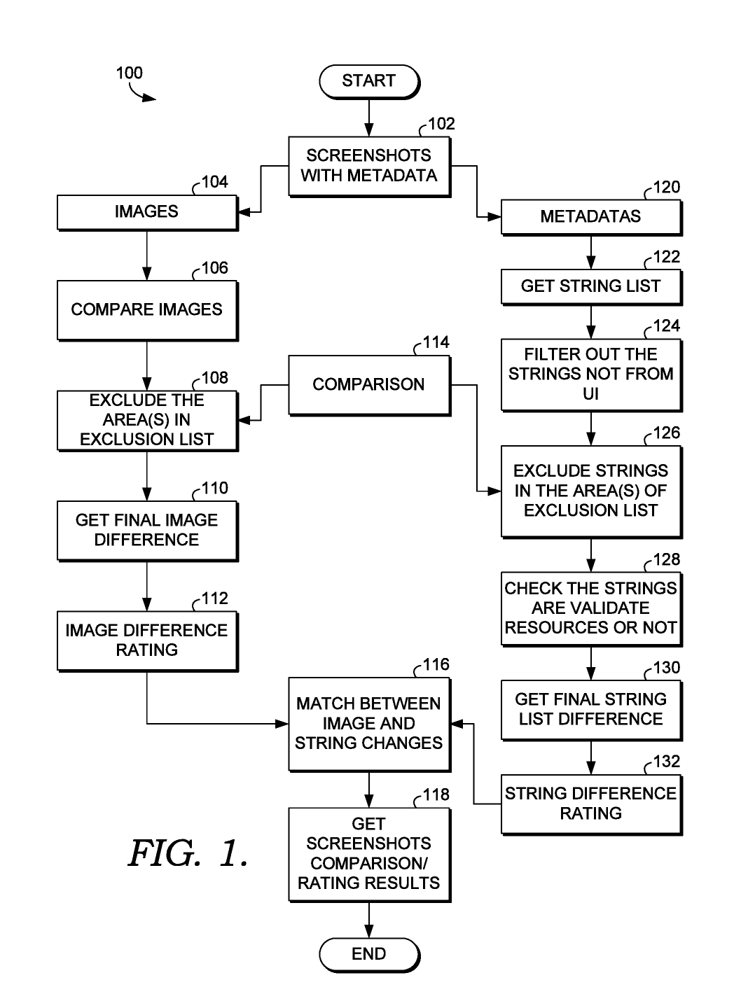

FIG. 1 shows an example of a process flow 100 for identifying objects in a user interface that have changed relative to a baseline version. The process flow 100 in FIG. 1 could, for example, be part of an overall process flow for performing quality assurance on an application during an update cycle. Process flow 100 can begin with obtaining images (such as screenshots) and corresponding metadata for a baseline version of a user interface and a version of the user interface for comparison. The baseline version of a user interface can correspond to an original or initial version of the user interface; a prior updated version of the user interface that was released to users; a user interface version designated as a baseline user interface version for any convenient reason; or a combination thereof. The “revised” version of the user interface for comparison can correspond to any convenient version of the user interface.

When a user interface screenshot or other image is captured, such as a baseline version or a version for comparison, the image can be captured along with metadata associated with the image. In some aspects, the metadata associated with the image can correspond to text displayed as a part of the user interface. Typically such text can correspond to text associated with a user interface object in the user interface. Optionally, the associated metadata can also include underlying specifications of the properties for objects in the user interface. In such optional aspects, the metadata can include, but is not limited to, source code (such as XML code or HTML code) specifying the properties of an object, such as size of a text box, potential states for a button or widget, or contents of a drop down menu; a location in a hierarchical file storage system for where to retrieve the object or portions of the object; positioning location for the object; and/or any other information typically found in code for specifying the content and properties of a user interface.

The images 104 and the metadata 120 can be processed according to separate flow paths. In some aspects, metadata 120 can correspond to text associated with the user interface and/or associated with user interface objects. Additionally or alternately, metadata 120 can correspond to other types of metadata related to properties of user interface objects. In FIG. 1, the image for the baseline version of the user interface and the image for the revised version can be compared 106 using any convenient method for image comparison. For example, if the images are stored in a format based on pixel values, the images can be compared on a pixel-by-pixel basis. Suitable image formats can include, but are not limited to, RGB format, jpg/png format, bitmap format, and cap format. The comparison 106 of the baseline image and the image from the revised version can allow for identification of one or more groups of pixels that differ between the images. In some aspects, the detected differences can simply correspond to an identification of pixels that have different color or display values between the user interface images. In other aspects, additional comparison logic can be used to characterize the nature of differences. For example, if two user interface images contain the same objects (i.e., same size, same visual appearance), but with shifted locations, the differences can optionally be identified on the basis of translation of image portions, as opposed to identifying pixel locations that are changed between the images. In such aspects, differences between user interfaces that represent only changes in coordinates for existing user interface objects can optionally be classified differently from differences that correspond to changes in existing user interface objects and/or inclusion or removal of user interface objects.

In some aspects, metadata 120 can include text strings associated with the user interface. Typically the text strings associated with a user interface can be text strings associated with user interface objects of the user interface. The metadata 120 can be compared, for example, by extracting the text strings associated with the user interface from the metadata to allow for comparison. The structure of the metadata can be used to extract the text strings from the metadata. The text strings can optionally be identified for extraction based on the format of the metadata. This can allow for generation of a text string list 122.

The text strings extracted from the metadata may also include some text strings that are not directly related to the user interface. For example, a portion of the extracted text strings may correspond to text associated with a web browser that is used to display a user interface, as opposed to the user interface itself. In some optional aspects, such text can be filtered 124 prior to performing further processing.

In other optional aspects, metadata 120 can include strings related to specifying object properties for user interface objects. For example, if the metadata corresponds to an XML format or HTML format file, the structure of the metadata can be used to separate the metadata into strings of features about the captured image. The strings can correspond to, for example, user interface objects, properties for user interface objects, and supporting declarations regarding how to display the user interface and/or objects in the user interface. More generally, any convenient method may be used for extracting relevant strings from the metadata corresponding to a user interface image. Depending on the nature of how strings are extracted from the metadata, in some aspects a string can correspond to a user interface object plus all supporting properties for the user interface object. In other aspects, a string can correspond to a portion of a specification for a user interface object, such as a declaration of the object, a location for the object, a property for the object, or another feature related to a user interface object. In such aspects, each string can include a single declaration, location, property, and/or other feature; or a string can potentially include multiple declarations, locations, properties, and/or other features.

Optionally, it may be desirable to exclude portions of the image and the corresponding metadata from further consideration. For example, some user interfaces can correspond to user interfaces displayed in a web browser. When a screenshot or other image of such a user interface is captured, the web browser used to display the user interface can be captured along with the user interface, even though the web browser is not actually part of the user interface. As another example, it may be known in advance that a portion of a user interface is unchanged and/or that it is not desired to test a portion of the user interface. This could correspond to a portion of the user interface that always displays a new feature that is under construction; a portion that always displays a logo or other non-interactive feature; or it may be desirable to focus the comparison between user interfaces to particular sections. Regardless of the reason, it can be beneficial in some aspects to exclude a portion of the user interface during comparison. This can save substantial amounts of time by avoiding situations where a trivial change in the web browser used to display a user interface might result in identification of a user interface as being changed, even though the user interface itself is not changed between versions. For example, if it is known that the baseline version of a user interface includes a prior version of the corporate logo, exclusion of the corporate logo portion of the user interface can avoid identification of all user interfaces in the application as having an image change.

Exclusion can be performed, for example, by using an exclusion list to specify a predetermined mask of pixels within a screenshot that correspond to the desired exclusion area (or areas). This can allow for exclusion 108 of differences identified during comparison of the baseline version and a second version where the differences occur within the masked or excluded area. For the metadata (such as text associated with the user interface), the exclusion list can be defined in any convenient manner for exclusion 126 of strings corresponding to the excluded area(s). One option can be to exclude portions of metadata that reference or otherwise are associated with pixel positions within the masked or exclusion area in the corresponding images. Another option can be to specify types of metadata strings for exclusion, such as metadata strings related to the browser for displaying a user interface. It is noted that in aspects where filtering 124 of text strings is used, some text strings that are filtered out may also correspond to strings that would be excluded during exclusion 126. In some aspects, a comparison 114 can also be performed to determine a) if any excluded strings of metadata correspond to portions of the image outside of the excluded area and/or b) if any excluded portions of the images correspond to metadata strings that have not been excluded. This can allow for increased consistency between the excluded portions of the images and the metadata strings.

After performing exclusion, a final list of image differences can be obtained 110. The final list of image differences can then be used to determine 112 an image difference rating. The image difference rating can characterize the nature of any differences between images. As an example of a potential rating system, if there are no differences between images (except for the exclusion areas), the images can be assigned a first type of difference rating. If the user interface objects in the images are the same but the coordinates or locations for the user interface objects have changed, the images can be assigned a second type of difference rating. In some aspects, text displayed in association with a user interface object may have a coordinate or location change while the associated object remains in the same location. This can optionally be assigned the second type of difference rating, or a third type of difference rating can be used for a text-only coordinate changed. Finally, if there are differences in the types of objects displayed in the user interface, a fourth type of difference rating can be assigned.

In another example of a potential rating system, the types of difference ratings available for assignment can correspond to 1) no change between images, 2) change of text coordinates/location between images, and 3) change between images. In such an example, a change in text can potentially be the change between the baseline version of a user interface image and the revised version of the user interface image. Still other examples of how to assign difference ratings based on the nature of changes between images will be apparent to those of skill in the art.

With regard to the metadata, after performing exclusion, the list of extracted strings for both the baseline version and the revised version of the user interface can then be optionally checked 128 to verify the text strings that corresponds to a validated text string in the user interface. As noted above, hash values can be associated with some or all of the text strings in a user interface. In aspects where at least a portion of the text strings in a user interface have a separate hash value, the comparison between text strings can be performed on the text strings having a hash value. The text strings without a hash value can be omitted from the text string comparison. This can generate a final string list for both the baseline version of the user interface and the revised version of the user interface. In this type of aspect, the comparison between text strings can then be performed by comparing the hash values. If the hash values are the same for the baseline version of the user interface and the revised version of the user interface, then no change in text strings is present.

Based on the determined differences between the baseline version user interface strings and the revised version user interface strings, a string difference rating can be assigned. If there are no changes, a first type of string difference rating can be assigned. If there are changes in the strings between the baseline version of the user interface and the revised version of the user interface, a second type of string difference rating can be assigned.

After assigning both an image difference rating and a string difference rating, the differences between the images can be compared with the differences between the text strings in order to identify matches between the image differences and the text string differences. Matching between an image difference and a text string difference is defined as having an image difference where the source of the image difference can be identified as also corresponding to a text string difference. This could be based on a match between the pixels identified as changed in the image and a coordinate/location specification for a text string that is changed. Optionally, this type of match could correspond to having a coordinate/location specification for a changed text string that is within a desired range of pixels from a changed area of pixels in the image. Another option for matching an image difference and a text string difference can be based on determining that an image difference corresponds to a change in a user interface object (such as a change in a user interface object property or user interface object position) based on the metadata, and also determining that a text string associated with the user interface object has changed.

Based on any matches between the image differences and the string differences, a rating type can then be assigned. In particular, when a match occurs between an image difference and a string difference, an additional matching difference rating can be assigned. This can reflect the fact that an image change that is matched with a string change can provide a confirmation of an intended change in the user interface in the revision. It can be desirable to perform quality assurance testing on any such intended changes. By contrast, when image changes and/or string changes are determined, but no match is found between an image change and a string change, the lack of matching can indicate that a change of lower importance with regard to testing. As another example, when the location of a text string is changed without changing the text, the matching difference rating can be assigned if the change in text string location can be matched with the image change.

The various rating values above for the differences between images and/or text strings can then be combined to provide an overall difference rating between the baseline version of the user interface and the revised version. This overall difference rating can then be used, for example, to determine if the user interface has changed enough that testing is required.

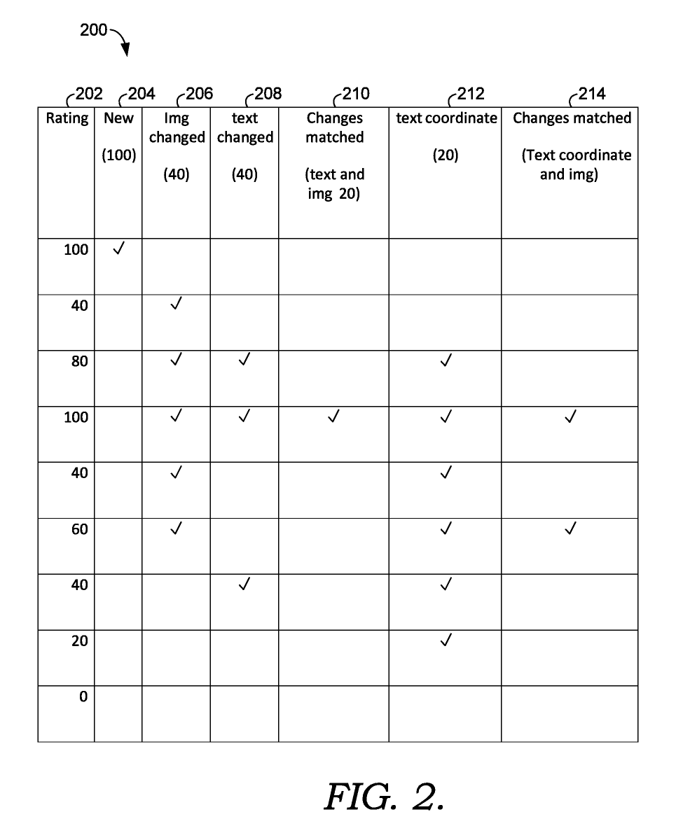

FIG. 2 shows an example 200 of rating values that can be assigned for various types of changes between a baseline version of a user interface and a revised version of a user interface. In the example 200 of a rating system, a user interface can be assigned a rating 202 based on the types of differences identified between a baseline version and a “revised” version of a user interface. For a user interface that is new 204, a rating value of 100 can be assigned, as a new user interface can always be exposed to testing. An alternative way of considering a new user interface is that there is not a baseline version available for a comparison. For user interfaces that have an existing baseline version, one type of difference relative to a revised version can be whether the image has changed 206. Another type of difference is whether any text strings have changed 208. It is noted that in the example in FIG. 2, image changes and text string changes are given a similar rating of 40. When both image and text string changes are present, a user interface is likely to be subjected to additional testing, as having both an image change and a text string change results in a combined rating 202 of 80. The rating 202 increases to 100 (the maximum in this example) if at least one image change and one text string change correspond to a matched change 210. In some aspects, if the text is not changed 208 but the coordinates for a text string are changed 212, a rating 202 of 20 can be assigned. This rating value for text coordinate change is not assigned when the content of a text string is changed. Additionally, if only a text string coordinate change is present (and not a text string change), a match 214 between the text string coordinate change and an image change can add 20 to the rating score 202.

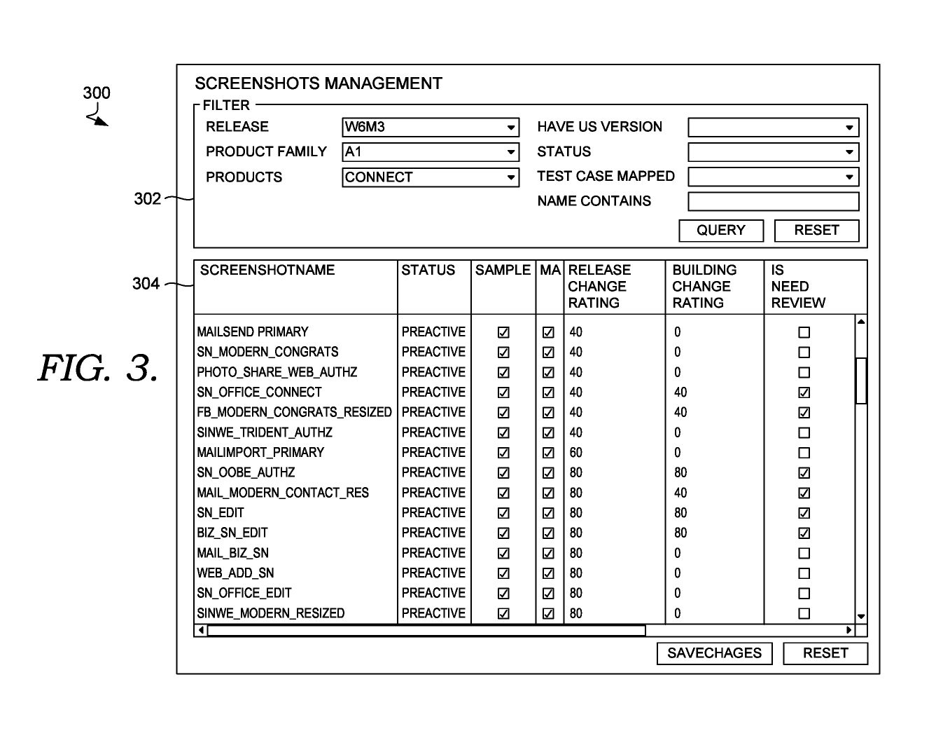

FIG. 3 shows an example of a user interface 300 for managing comparisons between baseline versions and other versions. In FIG. 3, user interface 300 includes a selection area 302 that can allow a user to filter the available list of screenshots based on various criteria, such as product family, release version, and product. Other filter fields include country version, status, whether a test case has previously been mapped, and a general search field.

Area 304 provides a listing of user interfaces that match the filter criteria from area 302. In area 304, both a release change rating 322 and a build change rating 324 are shown. In this example, a release change rating can correspond to a change rating relative to a baseline version based on the prior commercial release of the product. The build change rating represents a change rating relative to a baseline version defined by the user based on the current status of testing. In this type of strategy, the user interfaces in need of review can correspond to the user interfaces that have build change ratings of greater than 0.

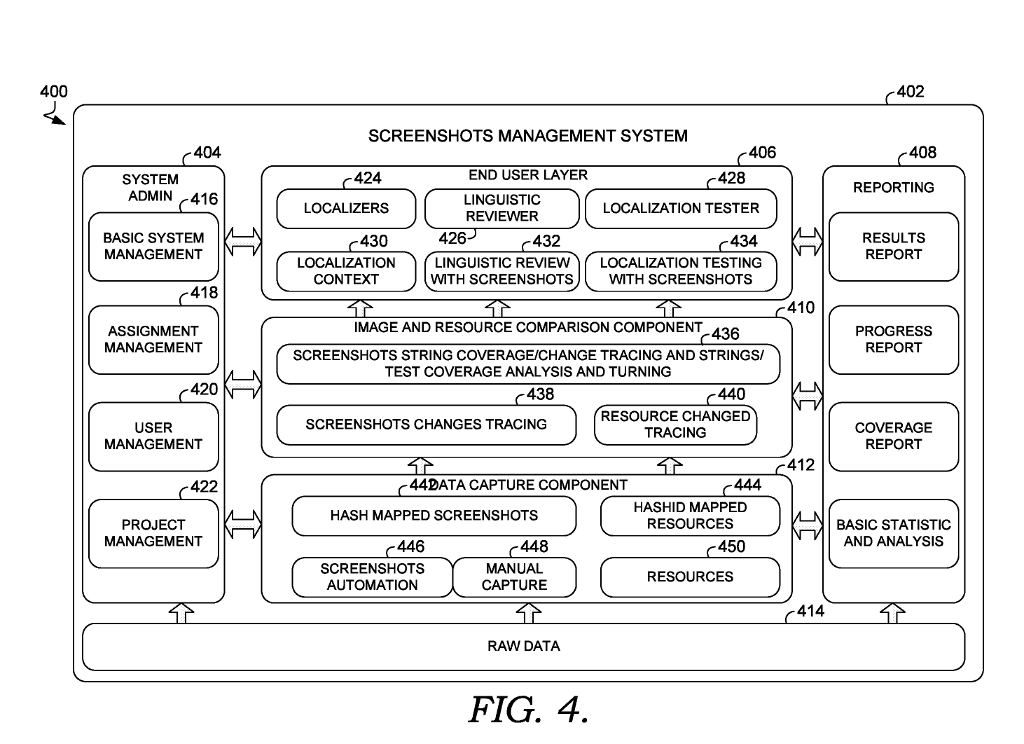

FIG. 4 provides an example of an overall system for managing changes for user interfaces. The screenshot management system 400 shown in FIG. 4 generally includes a system administration component 404, a reporting component 408, and a series of components for processing user interface images and corresponding metadata.

During operation of the system in FIG. 4, raw data 414 corresponds to the various types of raw data that can be used by a screenshots management system 400. This can screenshots, text strings, and versions of screenshots and text strings in alternate languages. Versions of screenshots in specific languages can be referred to as localization screenshots or localized screenshots. Resources can refer to text strings that may appear in a localized screenshot. The raw data 414 can also include data related to a desired testing schedule for meeting a release date for an application as well as results from performing testing on user interfaces after using the screenshot management tool 400 to determine that sufficient changes are present in a user interface to warrant testing.

The data capture component 412 of the screenshot management tool 400 can acquire images (such as screenshots) of a user interface. This can correspond to manual capture 448 of images as performed by a user as well as automated capture 446 of screenshots according to a schedule or based on triggering events. The data capture component 412 can also have access to stored resources 450, which correspond to text strings that can appear in a user interface. The resources 450 can include resources both in a primary working/testing language as well as resources in other languages that a user interface supports. For example, for a developer in the United States, English can be used as a primary working and testing language during development or revision of a user interface. In such an example, other supported languages such as Spanish can be supported by translating the English-based resources into Spanish-based resources. In some optional aspects, any screenshots obtained by a user can have a corresponding hash value 442 assigned to the screenshot. Having a hash value for a screenshot can provide a quick method for indicating whether two screenshots might be identical. For resources 450, resources with associated hash identifiers 442 can also be provided. In some aspects, hash identifiers can be determined for all resources (i.e., for text strings in all langauges). In other aspects, hash identifiers can be determined for resources in a primary or working language.

The screenshots and resources from the data layer 412 can be used by image AND resource comparison component 410 to determine differences between baseline versions and revised versions of user interfaces. It is noted that image and resource comparison component 410 can also correspond to a separate image comparison component and a separate resource comparison component if desired. Within image and resource comparison component 410, screenshot comparison component 438 can compare images of a user interface and/or hash values of images of a user interface to identify changes. Resource comparison component 440 can compare text strings of a user interface and/or hash values of text strings of a user interface to identify changes. Image and resource comparison component 410 can also match changes identified by screenshot comparison component 438 and resource comparison component 440. Ranking component 436 can then determine a change ranking for a user interface based on the output from screenshot comparison component 438 and resource comparison component 440.

After performing user interface comparison using image and resource comparison component 410, user interfaces can be passed to end user layer 406 for localization. This can include using localizers 424 to add any desired localization context 430 to a user interface. Localization context can refer to additional user interface objects, logos, schemes, or other modifications that are specific to use of the user interface in a particular country or other location. This can also include substituting text strings in a user interface with a resource in a language that matches the localization context 430. After localizing a user interface, a linguistic reviewer 426 can be used to perform linguistic review 432 on text strings in the context of a user interface based on localized screenshot. Localization testing 434 can also be performed on localized versions of the user interface using a localization tester 428.

The components in reporting component 408 can allow for generation of a variety of reports useful during testing and development of an application, such as progress reports, testing coverage reports, and other reports containing metrics useful to a developer or tester. The components in system administration component 404 can be any convenient types of components for managing a quality assurance system. The components shown for system administration component 404 are intended to be representative, and it is understood that other types an combinations of components could be included in other embodiments. In FIG. 4, the system administration component 404 can include, for example, basic system management component 416, assignment management component 418, user management component 420, and project management component 422. These assignment management component can allow screenshot testing tasks to be assigned to appropriate members of quality assurance team. The user management component 420 can determine which projects can be accessed by which users. Project management component 422 can track progress in testing of user interfaces for a project.

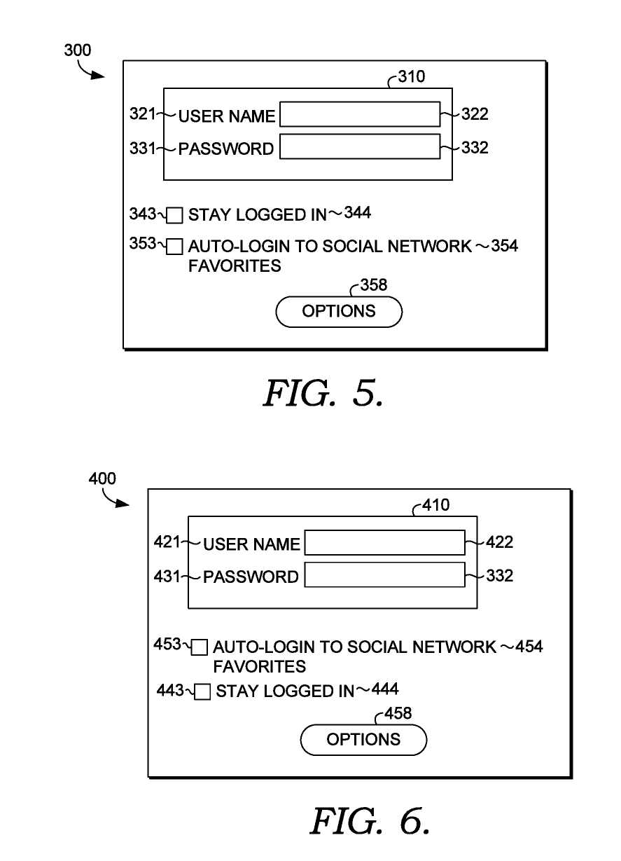

FIG. 5 shows an example of a user interface page that can be part of an exemplary application. The user interface illustrated in FIG. 5 could be part of an application on a desktop computing device, an “app” on a mobile device, a web page displayed as part of a service or product provided over a network, or part of any other convenient type of application. The user interface shown in FIG. 5 can correspond to a user interface for an authentication page. After authenticating a user, another user interface (not shown) can be displayed to a user to allow a user to engage in further activities.

In the user interface shown in FIG. 5, the outer frame 500 can be considered to correspond to an outer frame that is not part of the user interface, such as a web browser. This outer frame 500 can be excluded from consideration when comparing the user interface in FIG. 5 with another version of the user interface. An input/output dialog box 510 can include text box 522 for receiving a username and a text box 532 for receiving a password. The user can understand the function of text box 522 and text box 532 based on associated text string 521 and associated text string 531. In addition to dialog box 510, the user interface 500 also includes a check box 543 with associated text string 544 to allow a user to indicate if the user should remain logged in after closing the application. The user interface 500 further includes a check box 553 with associated text string 554 to allow a user to indicate if the user should also be logged in to any previously designated social networking sites. Finally, user interface 500 includes a button 358 that includes the text “button” within the user interface object. The text “button” is also considered to be associated with this user interface object.

To further illustrate the invention, the user interface shown in FIG. 5 can be considered an image corresponding to a baseline version of a user interface. FIG. 6 shows one example of a potential revised version of the user interface. In FIG. 6, the user interface is similar to the user interface in FIG. 5. However, the ordering of the check boxes 543 and 553 has been switched, as indicated by the ordering of the associated text string 544 and associated text string 554.

The differences between images of the user interface in FIG. 5 and the user interface in FIG. 6 can be captured based on the differences in the images and the differences in the text strings. Although check boxes 543 and 553 have switched positions, the text boxes themselves appear to be the same when comparing the images. The only change in the images corresponding to user interface 500 and user interface 600 is the location of associated text string 544 and associated text string 554. In this type of example, the image would be indicated as different based on the change in location of the user interface objects containing the associated text string 544 and the associated text string 554. Using the rating system from FIG. 2, this would count for 40 points for the difference between FIG. 5 and FIG. 6. With regard to changes in text string, no change in the text strings themselves is present, so no points are awarded for change in text string. However, the position of the associated text strings has changed. While this does not by itself result in additional points, the change in position of the associated text strings matches the change in the images, based (for example) on the pixel location for the changes in the images and the corresponding location specification for the text strings in the metadata for the user interface. This results in an additional 20 points based on matching the image change with the position change of the associated text strings, for a total rating of 60 for the differences between the baseline version of the user interface in FIG. 5 and the revised version in FIG. 6.

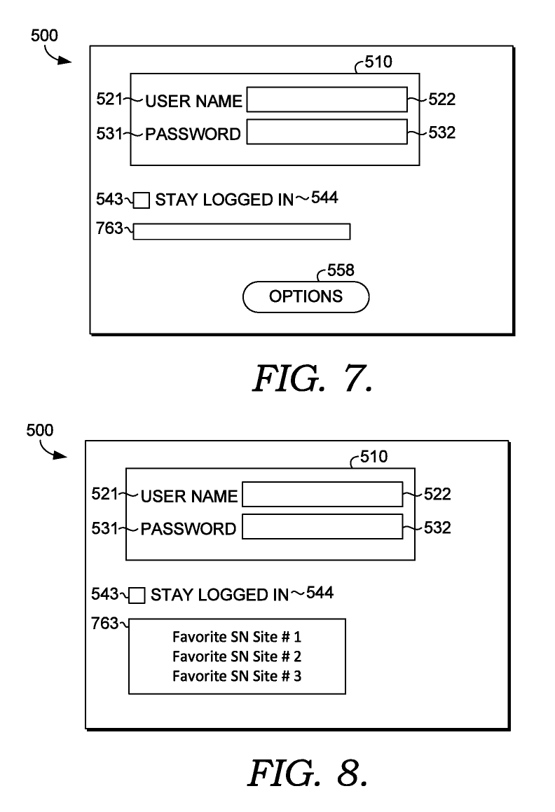

FIG. 7 shows another example of a revised user interface. Either FIG. 5 or FIG. 6 could be used as a baseline version for evaluation of the changes in FIG. 7. In this example, FIG. 5 is used as the baseline version. In FIG. 7, check box 553 has been replaced by drop down menu 763. Associated text 554 has also been removed. Based on these differences, using the rating method illustrated in FIG. 2, 40 points can be assigned for differences between the images. Another 40 points can be assigned due to a change in text string. In particular, the user interface object containing text string 554 has been removed. Finally, the changes in the image correspond to the changes in the text strings, based on the removal of the user interface object containing text string 554. Therefore, the difference rating between the user interface in FIG. 5 and the user interface in FIG. can be 100.

FIG. 8 shows another state of the user interface in FIG. 7. In FIG. 8, the drop down menu 763 in FIG. 7 has been activated by the user, resulting in display of the options available in drop down menu 763. This also obscures display of options button 558. Depending on the nature of how the user interface is tested, FIG. 8 can represent a state of the user interface that is naturally tested during testing. Alternatively, FIG. 8 could potentially represent a different a separate user interface. In this latter situation, FIG. 8 could represent a new user interface, or FIG. 5 could once again be used as a baseline version to allow for comparison.

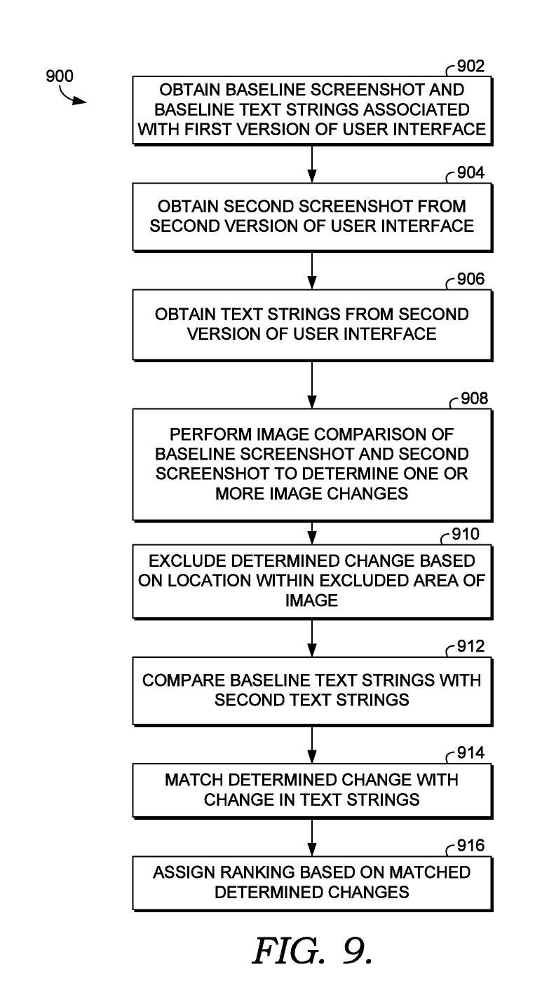

FIG. 9 shows an example of a process flow 900 for performing a method for comparing user interface versions as described herein. In process flow 900, a baseline user interface image and text strings associated with the baseline version of the user interface are obtained 902. The baseline versions of the image and text strings can be extracted from a stored image and associated metadata, or the baseline versions can be retrieved from storage. A second user interface image corresponding to a second version of the user interface can also be obtained 904. Text strings can also be obtained 906 from the second version of the user interface, such as by extraction of the text strings from metadata. An image comparison can then be performed 908 between the baseline version of the user interface and the second version of the user interface to determine changes between the images of the user interfaces. Optionally, at least one determined change can be excluded 910 from further consideration based on the at least one determined change being in an excluded area of the images. Optionally, the exclusion 910 can further include exclusion of one or more baseline text strings and/or extracted text strings. The baseline text strings can then be compared 912 with the extracted text strings, such as to determine one or more changes between the text strings. A determined change in the images can then be matched 914 with a change in the text strings. Based on the presence of a matched determined change, a ranking can be assigned 916 to the differences between the baseline user interface and the second version of the user interface. This assigned rating can then be used, for example, to determine if additional testing should be performed on the user interface.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

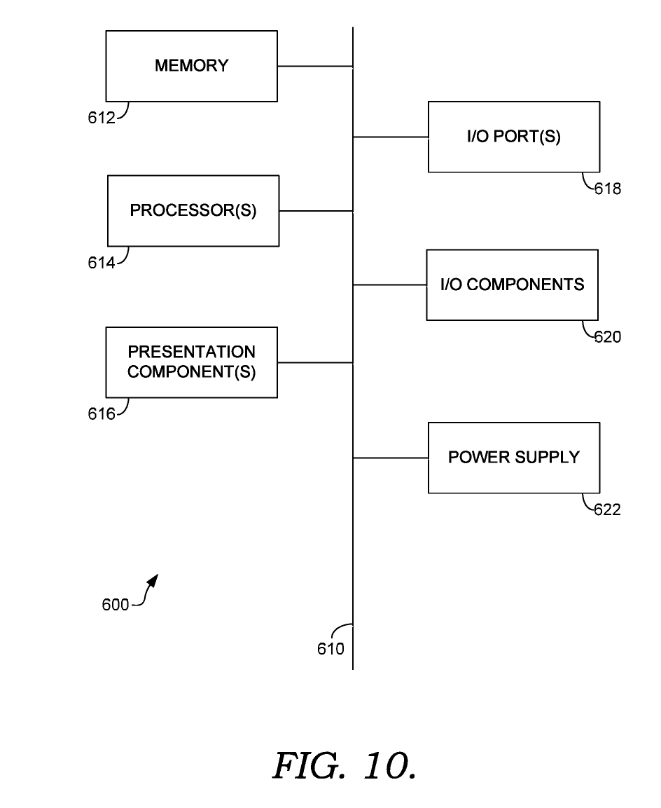

Having described embodiments of the present invention, an exemplary operating environment in which embodiments of the present invention may be implemented is described below in order to provide a general context for various aspects of the present invention. Referring initially to FIG. 10 in particular, an exemplary operating environment for implementing embodiments of the present invention is shown and designated generally as computing device 1000. Computing device 1000 is but one example of a suitable computing environment and is not intended to suggest any limitation as to the scope of use or functionality of the invention. Neither should the computing device 1000 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 10, computing device 1000 includes a bus 1010 that directly or indirectly couples the following devices: memory 1012, one or more processors 1014, one or more presentation components 1016, input/output ports 1018, input/output components 1020, and an illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 10 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc.

### Additional Embodiments

In an aspect, a system for detecting changes in a user interface is provided, comprising: a data capture component for obtaining a baseline user interface image corresponding to a first version of a user interface, baseline text strings associated with the first version of the user interface, a second user interface image corresponding to a second version of the user interface, and second text strings from the second version of the user interface; a hashing component for determining hash values associated with at least one of the baseline text strings and the second text strings; an image comparison component for performing an image comparison on the baseline user interface image and the second user interface image to determine one or more changes between the baseline user interface image and the second user interface image, the image comparison component further comprising a matching component for matching at least one determined change with an identified change between the baseline text strings and the extracted text strings; a resource comparison component for comparing hash values associated with the baseline text strings and hash values associated with the extracted text strings to identify changes between the baseline text strings and the extracted text strings; and a ranking component for assigning a testing ranking to the second version of the user interface based on the matched determined change.

In another aspect, method for detecting changes in a user interface is provided, the method comprising: obtaining a baseline user interface image corresponding to a first version of a user interface and baseline text strings associated with the first version of a user interface; obtaining a second user interface image corresponding to a second version of the user interface; extracting text strings from the second version of the user interface; filtering the extracted text strings to remove at least one text string not associated with the second version of the user interface; performing an image comparison on the baseline user interface image and the second user interface image to determine one or more changes between the baseline user interface image and the second user interface image; comparing the baseline text strings with the extracted text strings; matching a determined change to at least one of a) a location change of an extracted text string relative to a baseline text string or b) a change in an extracted text string relative to a baseline text string; and assigning a testing ranking to the second version of the user interface based on the matched determined change.

In still another aspect, a method for detecting changes in a user interface is provided, the method comprising: obtaining a baseline user interface image corresponding to a first version of a user interface and baseline text strings associated with the first version of a user interface; obtaining a second user interface image corresponding to a second version of the user interface; extracting text strings from the second version of the user interface; performing an image comparison on the baseline user interface image and the second user interface image to determine one or more changes between the baseline user interface image and the second user interface image; excluding at least one determined change based on the determined change corresponding to an excluded location; comparing the baseline text strings with the extracted text strings; matching a determined change to at least one of a) a location change of an extracted text string relative to a baseline text string or b) a change in an extracted text string relative to a baseline text string; and assigning a testing ranking to the second version of the user interface based on the matched determined change.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A method for detecting changes in a user interface, comprising:
obtaining a baseline user interface image corresponding to a first version of a user interface and baseline text strings associated with the first version of a user interface;
obtaining a second user interface image corresponding to a second version of the user interface;
extracting text strings from the second version of the user interface;
performing an image comparison on the baseline user interface image and the second user interface image to determine one or more changes between the baseline user interface image and the second user interface image;
excluding at least one determined change based on the determined change corresponding to an excluded location;
comparing the baseline text strings with the extracted text strings;
matching a determined change to at least one of a) a location change of an extracted text string relative to a baseline text string or b) a change in an extracted text string relative to a baseline text string; and
assigning a testing ranking to the second version of the user interface based on the matched determined change.

2. The method of claim 1, wherein comparing the baseline text strings with the extracted text strings comprises comparing one or more hash values associated with the baseline text strings with one or more hash values associated with the extracted text strings.

3. The method of claim 1, wherein obtaining a second user interface image corresponding to a second version of the user interface comprises capturing a screenshot of the second user interface.

4. The method of claim 1, wherein the baseline user interface image further comprises metadata, the metadata comprising the baseline text strings.

5. The method of claim 1, wherein performing an image comparison on the baseline user interface image and the second user interface image comprises identifying one or more groups of pixels having different pixel values between the baseline user interface image and the second user interface image.

6. The method of claim 1, wherein performing an image comparison on the baseline user interface image and the second user interface image comprises identifying at least one user interface object that is changed between the baseline user interface image and the second user interface image.

7. The method of claim 6, wherein the changed at least one user interface object comprises a user interface object that is new in the second user interface image or a user interface object that is removed in the second user interface image.

8. The method of claim 6, wherein the changed at least one user interface object comprises a user interface object that has at least one property in the baseline user interface image that is different in the second user interface image, the at least one property corresponding to a property different than a location property of the at least one user interface object.

9. The method of claim 1, further comprising filtering the extracted text strings to remove one or more text strings not associated with the second user interface.

10. One or more computer storage media containing executable instructions that, when executed, provide a method for detecting changes in a user interface, the method comprising:
obtaining a baseline user interface image corresponding to a first version of a user interface and baseline text strings associated with the first version of a user interface;
obtaining a second user interface image corresponding to a second version of the user interface;
extracting text strings from the second version of the user interface;
filtering the extracted text strings to remove at least one text string not associated with the second version of the user interface;
performing an image comparison on the baseline user interface image and the second user interface image to determine one or more changes between the baseline user interface image and the second user interface image;
comparing the baseline text strings with the extracted text strings;
matching a determined change to at least one of a) a location change of an extracted text string relative to a baseline text string or b) a change in an extracted text string relative to a baseline text string; and
assigning a testing ranking to the second version of the user interface based on the matched determined change.

11. The one or more computer storage media of claim 10, further comprising excluding at least one determined change from the performing an image comparison based on the determined change corresponding to an excluded location; and excluding at least one extracted text string based on the extracted text string corresponding to an excluded location.

12. The one or more computer storage media of claim 11, wherein the at least one extracted text string is excluded after comparing the extracted text strings with the at least one determined change to match the at least one determined change with the at least one extracted text string.

13. The one or more computer storage media of claim 10, wherein performing an image comparison on the baseline user interface image and the second user interface image comprises identifying at least one user interface object that is changed between the baseline user interface image and the second user interface image.

14. The one or more computer storage media of claim 13, wherein the changed at least one user interface object comprises a user interface object that is new in the second user interface image or a user interface object that is removed in the second user interface image.

15. The one or more computer storage media of claim 13, wherein the changed at least one user interface object comprises a user interface object that has at least one property in the baseline user interface image that is different in the second user interface image, the at least one property corresponding to a property different than a location property of the at least one user interface object.

16. A system for detecting changes in a user interface, comprising:
a data capture component for obtaining a baseline user interface image corresponding to a first version of a user interface, baseline text strings associated with the first version of the user interface, a second user interface image corresponding to a second version of the user interface, and second text strings from the second version of the user interface;
a hashing component for determining hash values associated with at least one of the baseline text strings and the second text strings;
an image comparison component for performing an image comparison on the baseline user interface image and the second user interface image to determine one or more changes between the baseline user interface image and the second user interface image, the image comparison component further comprising a matching component for matching at least one determined change with an identified change between the baseline text strings and the extracted text strings;
a resource comparison component for comparing hash values associated with the baseline text strings and hash values associated with the extracted text strings to identify changes between the baseline text strings and the extracted text strings; and
a ranking component for assigning a testing ranking to the second version of the user interface based on the matched determined change.

17. The system of claim 16, wherein the image comparison component further comprises an exclusion component for excluding at least one determined change corresponding to an excluded location.

18. The system of claim 16, wherein the data capture component obtains the second text strings by extracting the second text strings from the second user interface.

19. The system of claim 16, wherein the data capture component further comprises a filtering component to filter the extracted text strings to remove one or more text strings not associated with the second user interface.

20. The system of claim 16, wherein the image comparison component performs an image comparison by identifying one or more groups of pixels having different pixel values between the baseline user interface image and the second user interface image.
